(19) United States
(12) Patent Application Publication
(10) Pub. No.: US 2017/0250382 A1
(43) Pub. Date: Aug. 31, 2017

(54) STRUCTURES OF LITHIUM BATTERY CELL AND MANUFACTURING PROCESS THEREOF

(71) Applicant: AMITA TECHNOLOGIES INC LTD., Taoyuan City (TW)

(72) Inventors: Jing-Yih CHERNG, Taoyuan City (TW); Pin-Shiuan LI, Taoyuan City (TW)

(21) Appl. No.: 15/442,368

(22) Filed: Feb. 24, 2017

(30) Foreign Application Priority Data
Feb. 26, 2016 (TW) 105105972

(51) Int. Cl. H01M 2/02; H01M 10/0525; H01M 2/22; H01M 10/052; H01M 2/20

(52) U.S. Cl. CPC H01M 2/02; H01M 10/052; H01M 2/20; H01M 2/22; H01M 10/0525

(57) ABSTRACT

A flexible lithium battery includes a flexible pouch and two conductive tabs. The flexible pouch has an accommodating space and a being sealed side, and the two conductive tabs are inserted in the being sealed side and extended to the accommodating space. The being sealed side includes a first sealing area and a second sealing area, the first sealing area and the second sealing area are sealed to form a side seal through a combination means. The first sealing area has a first binding force, and the second sealing area has a second binding force. The second binding force is smaller than the first binding force, and gas accumulated in the accommodating space is discharged from the second sealing area.

### BACKGROUND OF THE INVENTION

Field of the Invention

The present invention generally relates to a lithium battery and, in particular to structures and manufacturing processes of a lithium battery cell.

Description of Prior Art

Lithium ion batteries have become a preferred battery for portable electronic products. A lithium battery usually makes use of chemical reactions of electrodes and electrolyte to generate electricity. However, when the battery cell does not work properly (for example, overcharging), the electrolyte and other materials will pyrolysis and produce combustible gas (i.e. hydrogen) during reacting processes. The gas maybe cause a pressure rising inside the cell and that will lead to a deformation of the shell, even an explosion will be occurred.

Therefore, the subject matter of the present invention is that how to design structures of battery cells for improving the safety of the battery cells and discharge combustible gas in the batteries timely in order to avoid explosion of the combustible gas accumulated in the battery cells.

In view of the above drawbacks, the Inventor proposes the present invention based on his expert knowledge and elaborate researches in order to solve the problems of prior art.

### SUMMARY OF THE INVENTION

Accordingly, an object of the present invention is to provide structures of a lithium battery cell and manufacturing processes thereof, wherein buildup gas can be discharged timely and not to be accumulated inside the batter cell, thus the internal pressure of the lithium battery cell will be maintained, and an explosion can be avoided.

In order to achieve the object mentioned above, the present invention provides structures of a lithium battery cell comprising a flexible pouch and two conductive tabs. The flexible pouch has an accommodating space and a being sealed side located at a periphery of the accommodating space. The two conductive tabs are inserted in the being sealed side and extended to the accommodating space. The being sealed side includes a first sealing area and a second sealing area, the first sealing area and the second sealing area are sealed to form a side seal through a combination means. The first sealing area has a first binding force, and the second sealing area having a second binding force, wherein the second binding force is smaller than the first binding force, and gas buildup in the accommodating space was discharged from the second sealing area.

In order to achieve the object mentioned above, the present invention provides manufacturing processes of a lithium battery cell, comprising: a) providing a flexible pouch and two conductive tabs; b) folding the flexible pouch to form a bag body with a being sealed side, the being sealed side of the bag body includes a first sealing area and a second sealing area; c) inserting the two conductive tabs in the being sealed side; and d)sealing the being sealed side with a combination means, and making a binding force of the seconding area smaller than that of the first sealing area.

Comparing with the prior art, the side seal of the structures of a lithium battery cell of the present invention includes a first sealing area and a second sealing area; the first sealing area and the second sealing area are sealed through a combination means that a binding force of the second sealing area is smaller than that of the first sealing area. Thus gas buildup was discharged from the second sealing area, and the internal pressure of the lithium battery cell will not be exceeded to cause an explosion, and operations of the other lithium battery cells will be performed normally.

### BRIEF DESCRIPTION OF DRAWING

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a manufacturing process schematic view of a lithium battery cell of the present invention.

FIG. 2 is a perspective schematic view of a lithium battery cell of the present invention.

FIG. 3 is a cross sectional view of a lithium battery cell of the present invention.

FIG. 4 is a cross sectional view of another embodiment of a lithium battery cell of the present invention.

FIG. 5 is a schematic view showing an operation of a lithium battery cell of the present invention.

FIG. 6 is a partial enlarged schematic view of the A portion of FIG. 5.

FIG. 7 is a partial perspective schematic view of another embodiment of a lithium battery cell of the present invention.

### DETAILED DESCRIPTION OF THE PREFERRED EMBODIMENTS

In cooperation with attached drawings, the technical contents and detailed description of the invention are described thereinafter according to a number of preferable embodiments, being not used to limit its executing scope. Any equivalent variation and modification made according to appended claims is all covered by the claims claimed by the present invention.

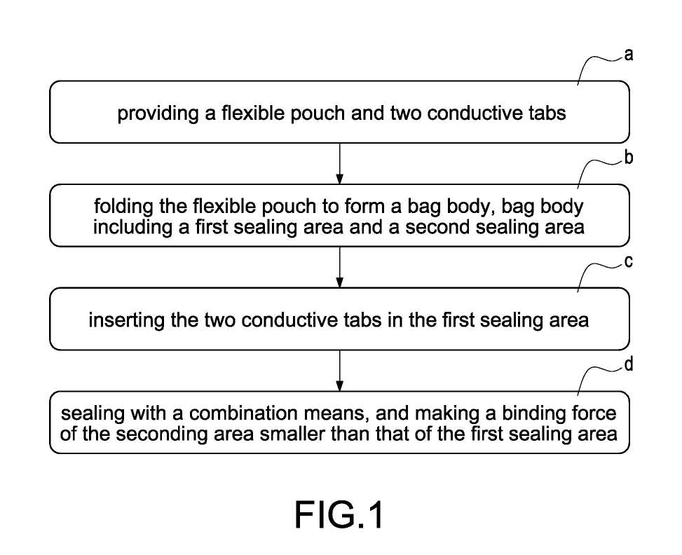

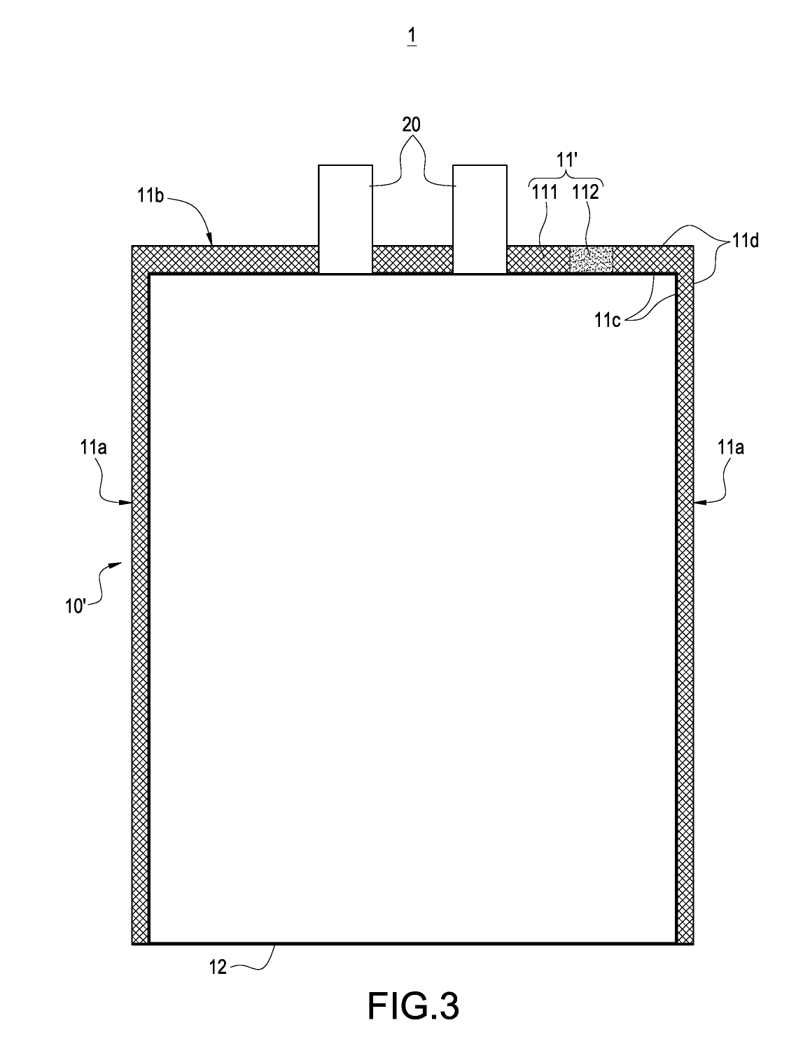

Please refer to FIG. 1 to FIG. 3, which depict a manufacturing process schematic view of a lithium battery cell of the present invention, a perspective view of and a cross sectional view of structures of a lithium battery cell of the present invention. As shown in FIG. 1, the manufacturing processes of a lithium battery cell of the present invention includes the following steps: a) providing a flexible pouch 10 and two conductive tabs 20; b) folding the flexible pouch 10 to form a bag body 10′ with a being sealed side 11′; the being sealed side 11′ of the bag body 10 includes a first sealing area 111 and a second sealing area 112; c) inserting the two conductive tabs 20 in the being sealed side 11′; and d) sealing the being sealed side 11′ with a combination means, and making an binding force of the seconding area 112 smaller than that of the first sealing area 111.

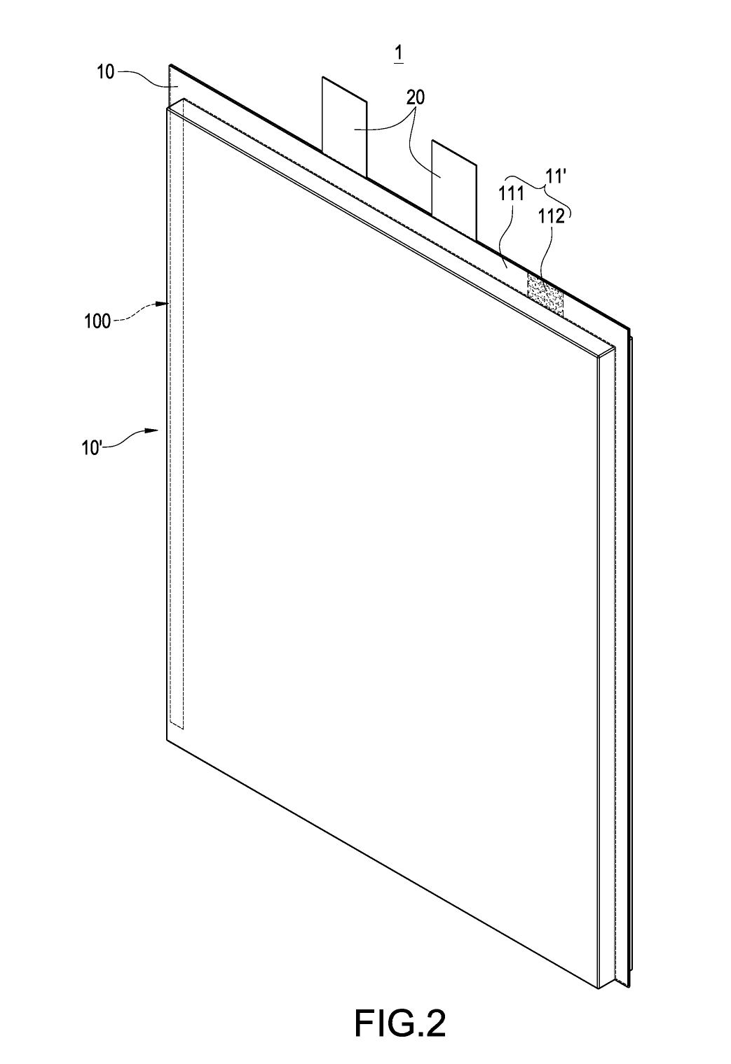

Please refer to FIG. 2, a lithium battery cell 1 configured by the processes showed in the FIG. 1 includes a flexible pouch 10 and two conductive tabs 20. The flexible pouch 10 is folded to form a bag body 10′, and the bag body 10′ has an accommodating space 100 and a being sealed side 11′ located at a periphery of the accommodating space 100. Preferably, the flexible pouch 10 is an aluminum foil bag.

Moreover, the two conductive tabs 20 are inserted in the being sealed side 11′ and extended to the accommodating space 100. The being sealed side 11′ includes a first sealing area 111 and a second sealing area 112; besides, the first sealing area 111 and the second sealing area 112 are sealed to form a side seal 11 through a combination means. In further, the first sealing area 111 has a first binding force, and the second sealing area 112 has a second binding force, wherein the second binding force is smaller than the first binding force.

More specifically, the flexible pouch 10 is folded and has a fold-edge 12 located at a side of the accommodating space 100. The side seal 11 includes two side-sealing edges 11a located at the right and left sides of the fold-edge 12 and an upper-sealing edge 11b located at the opposite side of the fold-edge 12, and the two conductive tabs 20 are inserted in the first sealing area 111 of the upper-sealing edge 11b. In addition, the side seal 11 includes an inner-sealing edge 11c neighboring the accommodating space 100 and an outer-sealing edge 11d in parallel with the inner-sealing edge 11c; preferably, the second sealing area 112 is extended from the inner-sealing edge 11c to the outer-sealing edge lid. Whereas the electrolyte filled in the lithium battery cell 1 and manufacturing processes thereof are well known in the art and will not be described further.

It is worth of noticing that the combination means can be implemented by combining processes such as hot melt, ultrasonic-welding or adhesion etc. In real practice, the first sealing area 111 and the second sealing area 112 have different combination forces through different combination means.

For example, when the combination means is provided with adhesion, the lithium battery cell 1 further includes a first adhesive and a second adhesive (not shown). The first sealing area 111 is sealed through the first adhesive, and the second sealing area 112 is sealed through the second adhesive, wherein the adhesive force of the second adhesive is smaller than that of first adhesive. Therefore, the second binding force of the second sealing area 112 is smaller than the first binding force of the first sealing area 111.

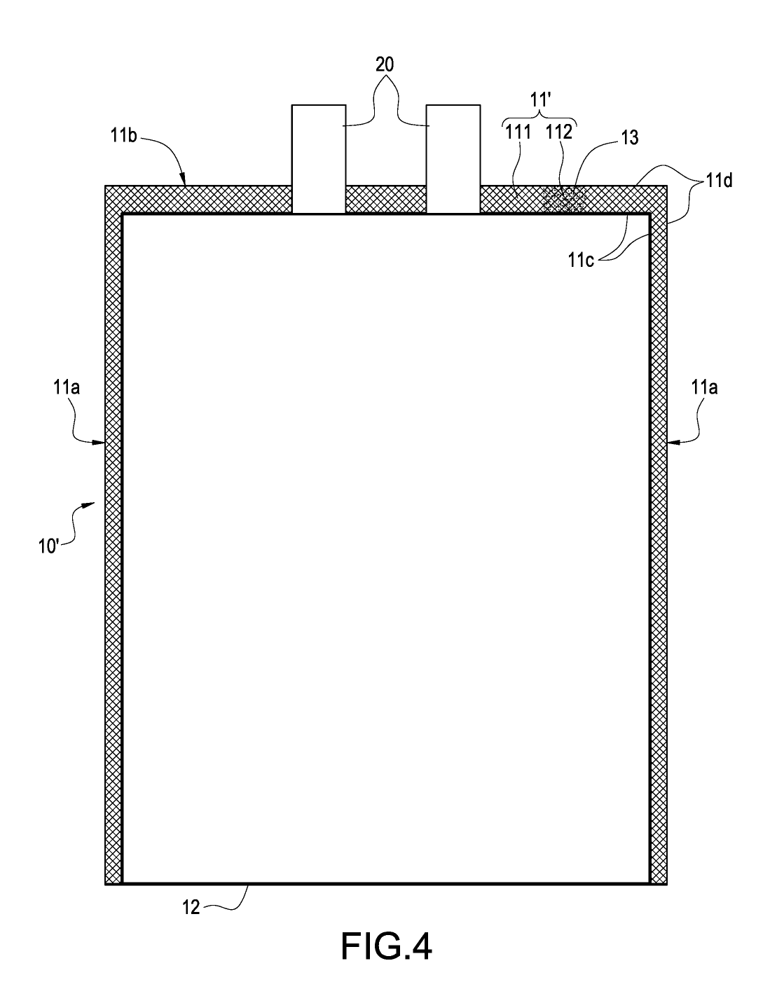

With referring to FIG. 4, it depicts a cross sectional view of another embodiment of a lithium battery cell of the present invention. The lithium battery cell 1 of the present invention further includes an additive 13. Besides, the additive 13, such as oil, wax or water, can be disposed in the second sealing area 112 for reducing the binding force after combining so that the first sealing area 111 and the second sealing area 112 will have different binding forces.

In the present embodiment, the additive 13 is disposed at the second sealing area 112. In addition, the first sealing area 111 and the second sealing area 112 are provided with the same combination means; the binding force of the second sealing area 112 is smaller than that of the first sealing area 111 by providing the additive 13.

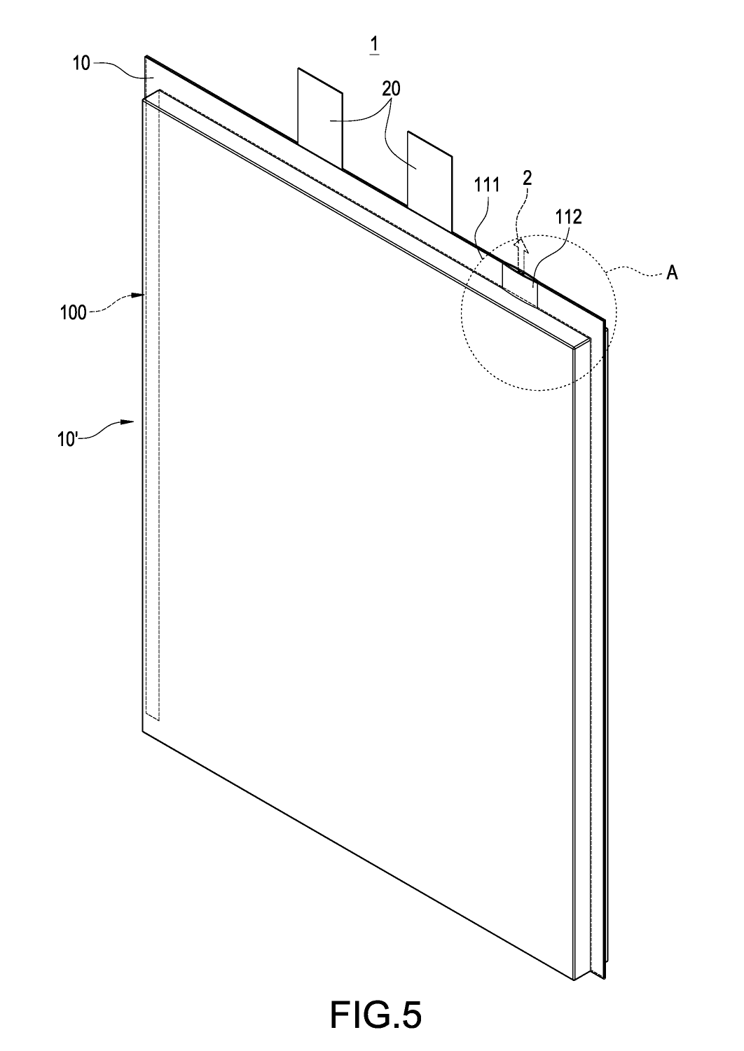

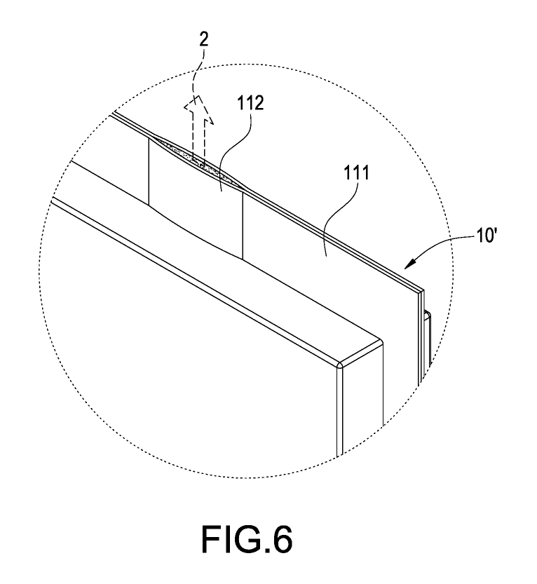

Please further refer to FIG. 5 and FIG. 6, which depict a schematic view showing a gas discharging and a partial enlarged schematic view of a lithium battery cell of the present invention. As shown in FIG. 5, when gas buildup in the accommodating space 100 of the bag body 10′ is accumulated to a certain amount, the pressure inside of the lithium battery cell 1 will be larger than the pressure outside, and then the gas 2 will find an outlet for discharging. Because the binding force of the second sealing area 112 is small, the gas 2 will be discharged from the second sealing area 112 to the outside. Thus the internal pressure of the lithium battery cell 1 will not be exceeded and cause an explosion, and operations of other lithium battery cells will be performed normally.

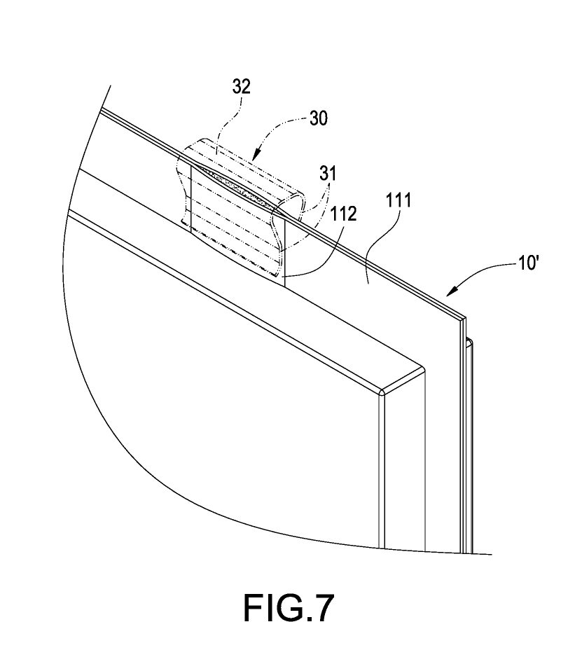

Please refer to FIG. 7, which depicts a partial perspective schematic view of another embodiment of a lithium battery cell of the present invention. As shown in the figure, the lithium battery cell 1 further includes a sealing clamp 30. The sealing clamp 30 is clamped at the second sealing area 112 for providing a clamping force of the second sealing area 112. Preferably, the sealing clamp 30 is a U-shaped clamp including two clamping clips 31 oppositely and a bent plate 32 connecting the two clamping clips 31. In real practice, the two clamping clips 31 are clipped at two sides of the second sealing area 112 correspondingly, and the bent plate 32 is located at an outer of the fold-edge 12.

As shown in FIG. 7, the deposition of the sealing clamp 30 will not obstruct the discharging of the gas 2 from the second sealing area 112, and the sealing clamp 30 clamps the second sealing area 112 after the gas 2 being discharged to the outside from the second sealing area 112. Thereby, the electrolyte inside the flexible pouch 10 can be prevented from leaking, and the safety of the lithium battery cell 1 will be enhanced.

In summary, the supporting spacer of the present invention can achieve the expected objective and overcome the disadvantages of the prior art. Also it is indeed novel, useful, and non-obvious to be patentable. Please examine the application carefully and grant it as a formal patent for protecting the rights of the inventor.

What is claimed is:

1. Structures of a lithium battery cell, comprising a flexible pouch and two conductive tabs, the flexible pouch having an accommodating space and a being sealed side located at a periphery of the accommodating space; the two conductive tabs being inserted in the being sealed side and extended to the accommodating space, the being sealed side including a first sealing area and a second sealing area, the first sealing area and the second sealing area being sealed to form a side seal through a combination means; the first sealing area having a first binding force, and the second sealing area having a second binding force, wherein the second binding force is smaller than the first binding force, and gas accumulated in the accommodating space is discharged from the second sealing area.

2. The structures of a lithium battery cell according to claim 1, wherein the flexible pouch is an aluminum foil bag.

3. The structures of a lithium battery cell according to claim 1, wherein the flexible pouch is folded and has a fold-edge located at a side of the accommodating space, the side seal includes two side-sealing edges located at the right and left sides of the fold-edge and an upper-sealing edge located at the opposite side of the fold-edge, and the two conductive tabs are inserted in the first sealing area of the upper-sealing edge.

4. The structures of a lithium battery cell according to claim 1, wherein the combination means include hot melt, ultrasonic-welding or adhesion.

5. The structures of a lithium battery cell according to claim 1, wherein the first sealing area and the second sealing area have different binding forces through different combination means.

6. The structures of a lithium battery cell according to claim 1, further including a first adhesive and a second adhesive, wherein the first sealing area is sealed through the first adhesive, the second sealing area is sealed through the second adhesive, and the adhesive force of the second adhesive is smaller than that of the first adhesive.

7. The structures of a lithium battery cell according to claim 1, further including an additive, wherein the second sealing area is disposed with the additive; the first sealing area and the second sealing area are provided with the same combination means; the binding force of the second sealing area is smaller than that of the first sealing area through deposing an additive.

8. The structures of a lithium battery cell according to claim 1, wherein the side seal includes an inner-sealing edge neighboring the accommodating space and an outer-sealing edge in parallel with the inner-sealing edge; the second sealing area is extended from the inner-sealing edge to the outer-sealing edge.

9. The structures of a lithium battery cell according to claim 1, further including a sealing clamp, the sealing clamp being clamped at the second sealing area.

10. The structures of a lithium battery cell according to claim 1, further including a sealing clamp, the sealing clamp being a U-shaped clamp including two clamping clips opposite to each other and a bent plate connecting the two clamping clips; the two clamping clips are clipped at two sides of the second sealing area correspondingly, and the bent plate is located at an outer side of the fold-edge.

11. A manufacturing process of a lithium battery cell, comprising:
a) providing a flexible pouch and two conductive tabs;
b) folding the flexible pouch to form a bag body with a being sealed side, the being sealed side of the bag body including a first sealing area and a second sealing area;
c) inserting the two conductive tabs in the being sealed side; and
d) sealing the being sealed side with a combination means, and making a binding force of the seconding area smaller than that of the first sealing area.

12. The manufacturing process of a lithium battery cell according to claim 11, further including providing an additive, wherein the additive is disposed in the second sealing area; a binding force of the second sealing area is smaller than that of the first sealing area through deposing an additive.
